(19) United States
(12) Patent Application Publication
(10) Pub. No.: US 2006/0056446 A1
(43) Pub. Date: Mar. 16, 2006

(54) Communication adapter switching method and apparatus

(75) Inventors: Hak-goo Lee, Suwon-si (KR); Yong-hoon Lee, Seoul (KR); Young-keun Kim, Incheon Metropolitan-City (KR); Pyung-soo Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/222,746

(22) Filed: Sep. 12, 2005

(30) Foreign Application Priority Data
Sep. 14, 2004 (KR) 10-2004-0073299
Dec. 7, 2004 (KR) 10-2004-0102304

(51) Int. Cl. H04J 3/22; H04J 3/16

(52) U.S. Cl. 370/465

(57) ABSTRACT

Provided is a communication adapter switching method and apparatus in a system having a plurality of communication adapters. The method includes: setting the addresses of the plurality of communication adapters equal to the address of the first of the plurality of communication adapters; setting a packet filtering mode of the communication adapters other than the first communication adapter to a mode in which all packets are accepted; and switching from one of the communication adapters to another when the one communication adapter is disconnected during communication. Accordingly, seamless handoff from the wired LAN to the wireless LAN is possible, since the TCP/IP session is maintained with the same IP address.

### CROSS-REFERENCE TO RELATED APPLICATIONS

This application claims the benefit of Korean Patent Application No. 10-2004-0073299, filed on Sep. 14, 2004 and 10-2004-0102304, filed on Dec. 7, 2004, in the Korean Intellectual Property Office, the disclosure of both of which are incorporated herein in their entirety by reference.

### BACKGROUND OF THE INVENTION

1. Field of the Invention

The present invention relates to a network field, and more particularly, to a communication adapter switching method and apparatus.

2. Description of the Related Art

In the Windows OS, a plurality of physical adapters for communication can be installed. Communication can be performed by allocating an Internet Protocol (IP) address to each of the physical adapters. Communication is attempted with another party by setting a session, using a pair consisting of a network layer IP address and a transport layer port address. If one of the pair is changed, the session is immediately disconnected.

If two of the same kind of physical adapter (e.g., 802.3) exist, different IP addresses are allocated to each physical adapter. When a communication application connects a communication session, one IP address is selected based on an optimal routing path, and communication with the other party is performed via the physical adapter to which the IP address is allocated. For example, even if physical adapters of other schemes, such as 802.3 and 802.11, exist, communication is performed in the same way as above.

If a user performs communication while simultaneously activating a wired local area network (LAN) and a wireless LAN, in a personal computer (PC) in which the Windows OS is installed, and which has different kinds of physical adapters, and if two of the physical adapters are connected to the same domain, the communication will generally be performed using the wired LAN, whose communication speed is faster. That is, the IP address used in this case will be the IP address allocated to the wired LAN. Here, if the wired LAN is disconnected, the Windows OS automatically disconnects a session of an application which uses transmission control protocol/user datagram protocol (TCP/UDP) communication, since the allocated IP address can no longer be used.

FIG. 1 shows kernel level libraries provided by Microsoft corporation to provide networking functions of the Windows OS. These libraries are called network driver interface specification (NDIS) drivers. An actual physical adapter needs a driver when it is connected to a peripheral component interconnect (PCI) interface, and this driver is a miniport driver provided by a developer so as to be suitable for an NDIS miniport specification. Accordingly, the actual physical adapter is activated, to receive packets from another party (LAN) and transmit the packets to an upper layer, and receive packets from the upper layer and transmit the packets to the LAN.

Popular TCP/IP and NETBIOS are actually called protocol drivers, and operate in an upper layer rather than the NDIS layer. Commonly, a kernel level is handled by protocol drivers, and applications belong to a user level.

Referring to FIG. 1, a network driver system includes a WIN32 packet driver 110, an upper level (LAN) protocol driver 120, an NDIS 130, an intermediate driver 140, miniport drivers 150 and 160, and network interface cards (NICs) 170 and 180.

Device drivers connect an operating system (OS) to input/output devices, analyze general requests received from the OS, and convert the requests to commands that specific peripheral controllers can understand.

The NICs 170 and 180 are physical devices operating as gateways transmitting and receiving data frames in a network.

The NDIS 130 provides an interface for communicating between at least one NIC driver and at least one protocol driver in an upper layer including the OS. That is, the NDIS 130 provides libraries of functions (called wrappers) used by an upper level (TCP/IP) driver and NIC drivers. The NIC drivers depend on the NDIS 130 for all kinds of external functions including communication with protocol drivers, registering and intercepting NIC hardware interrupts, and communication with the NICs 170 and 180 at the lower level.

NDIS drivers include the NIC drivers, the intermediate driver 140, and the upper level protocol driver 120.

A NIC driver manages a NIC. The NIC driver is directly interfaced to hardware (NIC) at a lower level and provides interfaces to upper level drivers above.

The miniport drivers 150 and 160, a type of NIC driver, transmit and receive data to and from the NICs 170 and 180 and perform hardware-oriented operations needed to manage the NICs 170 and 180. The miniport drivers 150 and 160 cannot directly call the OS. Instead, the miniport drivers 150 and 160 can call functions exported by the NDIS 130. Also, the miniport drivers 150 and 160 are interfaced to upper level drivers, such as the intermediate driver 140 and a transport protocol driver.

The intermediate driver 140 exists between an existing protocol driver and the miniport drivers 150 and 160. The intermediate driver 140 looks like a miniport driver to an upper level transport driver, and looks like a protocol driver to the miniport drivers 150 and 160. The intermediate driver 140 is mainly used to perform media conversion between the existing protocol driver and a miniport managing a new media type, which is not recognized by the existing protocol driver.

Since the intermediate driver 140 has an intermediate position among drivers, it communicates with the miniport drivers 150 and 160 at a lower level and the upper level protocol driver 120. The intermediate driver 140 provides a protocol entry point to a lower level and a miniport entry point to an upper level. The intermediate driver 140 is used for the NDIS 130 to transfer requests for the upper level protocol driver 120. The intermediate driver 140 looks like a miniport driver to the upper level protocol driver 120.

The upper level protocol driver 120 provides a transport driver interface (TDI) or an application-oriented interface in order to provide services to a user. The upper level protocol driver 120 transmits packets to lower level drivers by packeting data, allocating packets to the lower level drivers, and calling the NDIS 130. Also, the upper level protocol driver 120 provides a protocol interface to a lower level in order to receive packets from the lower level drivers. The transport protocol driver transmits received data to a proper client application.

As shown in FIG. 2, in the current Windows OS, if one communication line is disconnected between heterogeneous or homogeneous physical adapters, its associated session is automatically disconnected. In the case of TCP, information of media is stored in a TCP control block (TCB), and if information of interface disconnection is input, TCP automatically disconnects its associated session, since an IP address allocated to the interface can no longer be used. Even if TCP does not disconnect the session, the same IP address cannot be simultaneously allocated to another interface, in the Windows OS. If an attempt is made to allocate the same IP address to another interface, then since a TCP/IP protocol driver itself is turned down/up, all other existing sessions are disconnected.

Due to these problems, in order to pretend that only one interface exists when looking from the side of an actual protocol driver, the Windows OS uses a bridge function that can make virtual adapters. The bridge provides the same IP address to several interfaces. However, it takes around 30 seconds to perform handoff. That is, even using the bridge, if communication of one physical adapter is disconnected, a disconnection signal is automatically input to a virtual adapter generated by the bridge, and all sessions of the TCP/IP protocol driver are automatically disconnected. Also, it takes too much time to switch from one medium to another in the bridge scheme. Experimental results show that it takes 30 seconds or more to switch from one medium to another, and this time corresponds to a TCP timeout time. Therefore, even if information of disconnection is blocked, sessions are disconnected due to the TCP timeout.

### SUMMARY OF THE INVENTION

Additional aspects and/or advantages of the invention will be set forth in part in the description which follows and, in part, will be apparent from the description, or may be learned by practice of the invention.

The present invention provides a communication adapter switching method and apparatus for maintaining communication sessions of an application in an upper layer, and providing seamless communication when switching between heterogeneous communication adapters.

According to an aspect of the present invention, there is provided a communication adapter switching method in a system having a plurality of communication adapters, the method including: setting the addresses of the plurality of communication adapters to the same address of the first of the plurality of communication adapters; setting a packet filtering mode of the communication adapters other than the first communication adapter to a mode in which all packets are accepted; and switching from one of the plurality of communication adapters to another when the one communication adapter is disconnected during communication.

According to another aspect of the present invention, there is provided a communication adapter switching method in a system having a plurality of communication adapters, the method including: setting the media access control (MAC) address of a wired LAN communication adapter equal to the MAC address of a wireless LAN communication adapter, and setting a packet filtering mode of the wired LAN communication adapter to a promiscuous mode in which all packets are accepted; and switching from the wired LAN communication adapter to the wireless LAN communication adapter using wireless LAN information, when the wired LAN is disconnected during communication using the wired LAN communication adapter.

The communication adapter switching method may further include switching from the wireless LAN communication adapter to the wired LAN communication adapter using wired LAN information, when an event is generated informing or indicating that the wired LAN is connected during communication using the wireless LAN communication adapter.

The communication adapter switching method may further include setting a packet filtering mode of the wired LAN communication adapter to a direct, multicast, or broadcast mode.

The communication adapter switching method may further include mapping the wireless LAN information to a virtual adapter, if the wired LAN communication adapter is disconnected.

According to another aspect of the present invention, there is provided a communication adapter switching apparatus in a system having a plurality of communication adapters, the apparatus including: a virtual adapter which sets the addresses of the plurality of communication adapters to the same address of the first of the plurality of communication adapters, and sets a packet filtering mode of the communication adapters other than the first communication adapter to a mode in which all packets are accepted; and a virtual protocol driver which switches from one of the plurality of communication adapters to another when the one communication adapter is disconnected during communication.

According to another aspect of the present invention, there is provided a communication adapter switching apparatus in a system having a plurality of communication adapters, the apparatus including: a virtual adapter which sets the MAC address of a wired LAN communication adapter equal to the MAC address of a wireless LAN communication adapter, and sets a packet filtering mode of the wired LAN communication adapter to a promiscuous mode in which all packets are accepted; and a virtual protocol driver which switches from the wired LAN communication adapter to the wireless LAN communication adapter using wireless LAN information, when the wired LAN is disconnected during communication using the wired LAN communication adapter.

The virtual protocol driver may include a link state detector which provides a connection or disconnection state every time a connection or disconnection event is generated.

The virtual protocol driver may further include an optimal adapter selector which determines an optimal adapter for communication based on information provided by the link state detector.

Packets received from a physical adapter may be unconditionally transmitted to the virtual adapter, and packets to be transmitted to the physical adapter may be transmitted to the determined optimal adapter.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional network driver system;

FIG. 2 is a block diagram of a conventional network driver;

FIG. 3 is a block diagram of a network driver system according to an embodiment of the present invention;

FIG. 4 is a block diagram of an intermediate driver shown in FIG. 3;

FIGS. 5A and 5B are flowcharts illustrating a virtual driver loading process according to an embodiment of the present invention;

FIG. 6 is a flowchart illustrating a connecting operation according to an embodiment of the present invention; and

FIG. 7 is a flowchart illustrating a disconnecting operation according to an embodiment of the present invention.

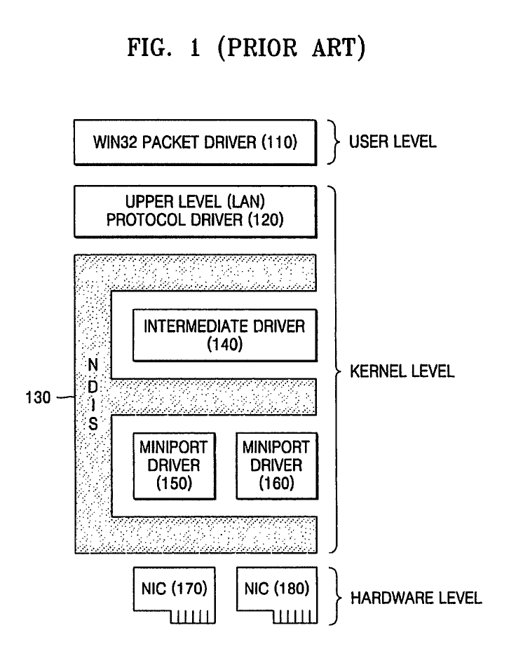

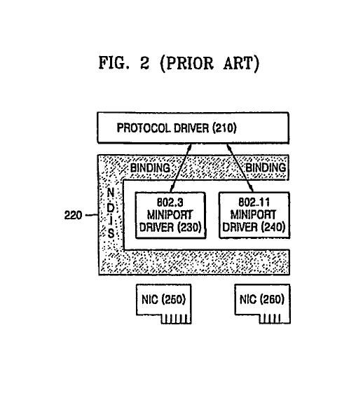

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, the present invention will now be described more fully with reference to the accompanying drawings, in which embodiments of the invention are shown.

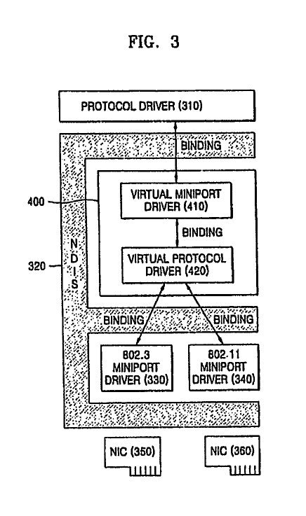

FIG. 3 is a block diagram of a network driver system according to an embodiment of the present invention.

According to the present embodiment, an actual miniport driver is bound only with a virtual protocol driver included in an internet driver. A virtual miniport driver is generated, and the virtual protocol driver is bound with the virtual miniport driver. Then an actual protocol driver, such as TCP/IP, is bound only with the virtual miniport driver. Therefore, the actual protocol drivers get information of connection states only with information from the virtual drivers, and transmit and receive all packets through the virtual drivers.

Referring to FIG. 3, the network driver system includes an intermediate driver 400 according to the present embodiment, NICs 350 and 360, an 802.3 miniport driver 330, an 802.11 miniport driver 340, protocol driver 310, and an NDIS 320.

The intermediate driver 400 includes a virtual protocol driver 420 at a lower level and a virtual miniport driver 410 at an upper level. That is, in the correlation between the virtual protocol driver 420 at the lower level of the intermediate driver 400 and the miniport drivers 330 and 340, the intermediate driver 400 has the function of a protocol driver, and in the correlation between the virtual miniport driver 410 at the upper level of the intermediate driver 400 and the protocol driver 310, the intermediate driver 400 has the function of a miniport driver. The virtual miniport driver 410 looks like an adapter to the protocol driver 310. Virtual adapters are generated to prevent sessions of a TCP/IP protocol driver from being disconnected due to disconnection information of an actual physical adapter. That is, the transmission of disconnection information from the actual physical adapter to the protocol driver 310 can be prevented by filtering, in the intermediate driver 400. Accordingly, the TCP session is continuously maintained.

Also, if there are two actual physical adapters, then since two IP addresses must be separately allocated to the two adapters, continuity of communication cannot be guaranteed. Therefore, the intermediate driver 400 is used as a virtual adapter linked to the two physical adapters. Accordingly, since an application layer (not shown) located over the protocol driver 310 communicates with one virtual adapter, the application layer does not care about the type and state of a physical adapter located under the virtual drivers.

Therefore, in the intermediate driver 400, a packet routing path can be changed. That is, in the intermediate driver 400, a communication medium is selected based upon the situation, and packets are transmitted and received via the physical adapter. Therefore, wired and wireless communication can be switched almost in realtime, without affecting the protocol driver 310.

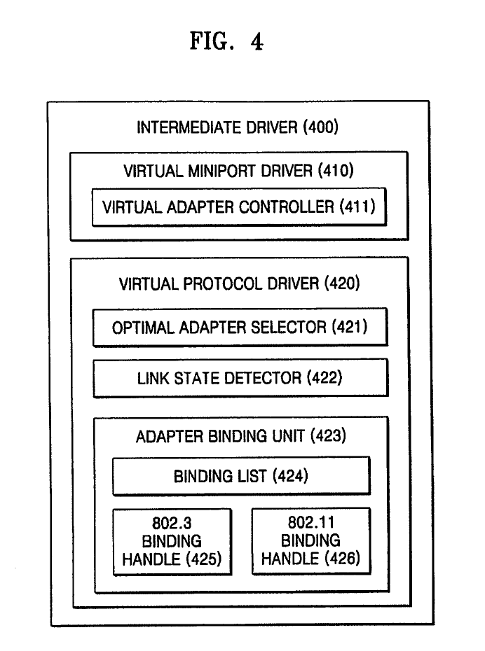

FIG. 4 is a block diagram of the intermediate driver 400 shown in FIG. 3.

Referring to FIG. 4, the intermediate driver 400 includes the virtual miniport driver 410 and the virtual protocol driver 420.

The virtual miniport driver 410 includes a virtual adapter controller 411. The virtual adapter controller 411 generates a virtual adapter and controls the virtual adapter so that the protocol driver 310 are bound to the virtual adapter and use the virtual adapter.

Also, when the virtual protocol driver 420 is bound to physical adapters, an attribute of each physical adapter is set. Here, the virtual adapter controller 411 sets the same address to each bound physical adapter. When setting is performed, in a case of a wired LAN, a packet filtering value is set to a promiscuous mode in which all of packets are accepted, and in a wireless LAN, the packet filtering value is set to a direct/multicast/broadcast mode, as is commonly used. The MAC address of the virtual adapter is set to the MAC address of the wireless LAN. That is, in the case of the wired LAN, the promiscuous mode is set and the MAC address of the wired LAN appears unset, and in the case of the wireless LAN, since a general mode is used, the MAC address of the virtual adapter depends on the MAC address of the wireless LAN. Therefore, in both cases, on the side of the protocol driver 310, only the MAC address of the wireless LAN appears to be set.

Retransmission of an address resolution protocol (ARP) packet to update a hub ARP table can be prevented by using the same MAC address. Also, when dynamic address allocation is performed using a dynamic host configuration protocol (DHCP), the MAC address is used to classify PCs by being used one option of DHCP. In this case, since a DHCP server recognizes the connected PCs as the same PC since they use the same MAC address, the virtual adapter can be used in a DHCP environment without any problem. Also, when an Internet protocol version 6 (IPv6) address is allocated according to auto-configuration using MAC addresses, in a next generation internet IPv6, since the MAC addresses are all the same, address allocation can be performed without any problem.

When the virtual adapter controller 411 requests information from protocol drivers in an upper layer, the virtual adapter controller 411 reports optimal adapter information selected by an optimal adapter selector 421 to the protocol drivers in the upper layer. That is, the virtual adapter controller 411 selects lower layer link state information and reports the selected information to the protocol drivers in the upper layer. Also, when the virtual adapter controller 411 transmits packets to physical adapters, the virtual adapter controller 411 transmits the packets using the binding handle of an optimal adapter selected by the optimal adapter selector 421.

The virtual protocol driver 420 includes the optimal adapter selector 421, a link state detector 422, and an adapter binding unit 423.

The optimal adapter selector 421 determines a physical adapter for communication according to connection information of wired or wireless LANs input from the link state detector 422.

The link state detector 422 detects link state information of the wired or wireless LANs and outputs the detected link state information to the optimal adapter selector 421.

The adapter binding unit 423 binds all of the enabled adapters and generates a binding list 424. The adapter binding unit 423 includes binding handles for controlling bound physical adapters. In the present embodiment, the adapter binding unit 423 includes an 802.3 binding handle for the wired LAN 425 and an 802.11 binding handle for the wireless LAN 426. Each binding handle is similar to a key used for the virtual adapter to communicate with a miniport driver in a lower level. Also, when the adapter binding unit 423 receives packets, it unconditionally transmits the packets to the virtual adapter.

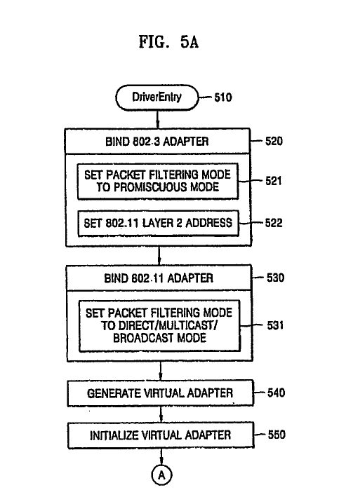

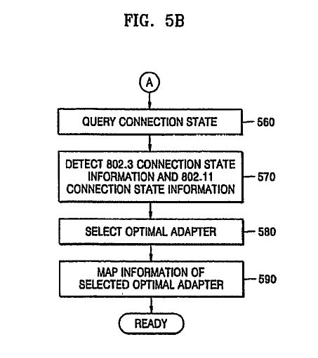

FIGS. 5A and 5B are flowcharts illustrating the process of initializing the intermediate driver 400 using a DriverEntry function according to an embodiment of the present invention. The DriverEntry function allocates a packet pool and a buffer pool for ARP, registers driver handles for miniport drivers 330 and 340 and a protocol handle for a protocol driver 310, and informs the NDIS 320 of association with the driver handles and the protocol handle. FIG. 5A illustrates the process of initializing the intermediate driver 400.

Referring to FIG. 5A, the initialization of the intermediate driver 400 starts from calling the DriverEntry function, which operates as an entry point of the intermediate driver 400 by an OS, in operation 510.

The virtual adapter controller 411 binds an 802.3 adapter in operation 520. A virtual adapter data structure is generated to store information of a physical adapter, every time the virtual adapter controller 411 binds a physical adapter. Therefore, as many data structures are generated as the number of physical adapters. The virtual adapter data structure is bound with actual protocol drivers in an upper layer. Binding handles of the physical adapters are obtained by binding the data structures with the physical adapters.

A binding handle data structure in the virtual adapter data structure stores a list of a plurality of data structures in the lower level.

In the 802.3 adapter binding process, a packet filtering attribute of the 802.3 wired LAN adapter is set to the promiscuous mode in operation 521. An adapter in the promiscuous mode accepts all the packets it receives.

The address of the wired LAN adapter is set to the MAC address of an 802.11 layer 2 wireless LAN adapter, in operation 522.

Accordingly, the 802.3 wired LAN adapter has the MAC address of the 802.11 wireless LAN adapter, and can receive all of the packets input through a wired LAN.

The virtual adapter controller 411 binds the 802.11 adapter in operation 530.

A packet filtering attribute of the 802.11 wireless LAN adapter is set to the direct, multicast, or broadcast mode, as is commonly used, in operation 531.

In the direct mode, a frame transmitted to a specific machine has a physical address (Ethernet address) of the destination machine assigned as the destination address. The machine having that physical address accepts the frame, and other machines do not accept the frame.

In the multicast mode, a frame (multicast frame) transmitted to a set of specific machines has a multicast address assigned as the destination address. The set of specific machines forms a multicast group. Therefore, every machine included in the multicast group can accept that frame. Even if a NIC does not belong to the multicast group, it can be programmed into the multicast mode in which all multicast frames are accepted.

In the broadcast mode, a frame transmitted to all machines in a network is broadcast to the network with a destination address of ‘0xffffff.’ The destination address ‘0xffffff’ is treated as a frame broadcast address. A NIC in the broadcast mode accepts all frames having the destination address ‘0xffffff.’ Commonly, all NICs are configured so that broadcast frames can be accepted.

After the binding is performed for all physical adapters, the virtual adapter controller 411 generates a virtual adapter in operation 540, and initializes the virtual adapter in operation 550. The initialization of the virtual adapter includes storing binding handle information by assigning the binding handle data structure, generating a binding handle list, and storing point information and binding handle information of the bound adapters in the binding handle list.

Referring to FIG. 5B, a connection state is queried using the virtual protocol driver 420, in operation 560.

The link state detector 422 included in the virtual protocol driver 420 which has received this query detects 802.3 connection state information and 802.11 connection state information, in operation 570, and transmits the detected connection state information to the optimal adapter selector 421.

The optimal adapter selector 421 selects an optimal adapter, in operation 580. When both the wired LAN and the wireless LAN are connected, the wired LAN is selected as the optimal adapter, since the wired LAN is faster, and when no wired LAN is connected, the wireless LAN is selected as the optimal adapter. The optimal adapter selector 421 transmits information of the selected optimal adapter to the virtual adapter controller 411.

The virtual adapter controller 411 maps the received information of the selected optimal adapter in operation 590. Then, the intermediate driver 400 is ready to communicate.

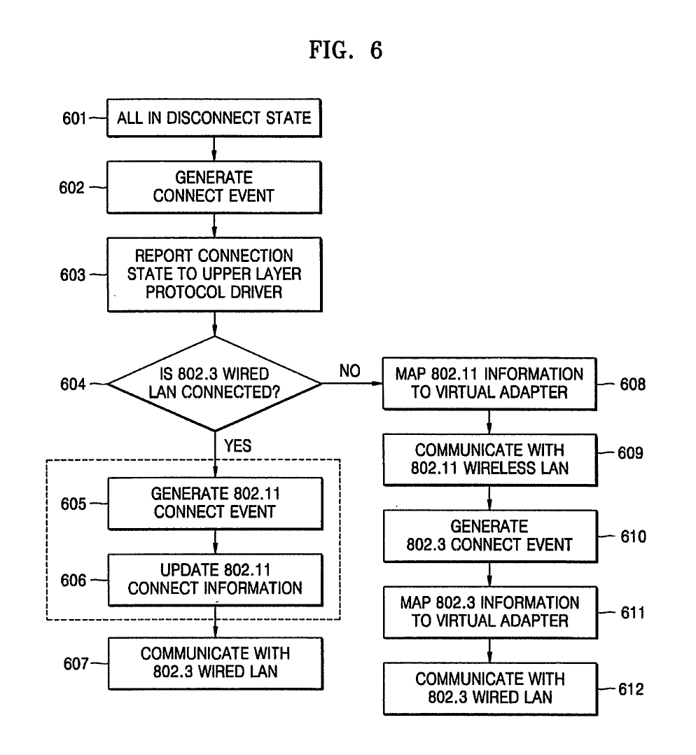

FIG. 6 is a flowchart illustrating a connecting operation according to an embodiment of the present invention.

Referring to FIG. 6, when an 802.3 wired LAN and an 802.11 wireless LAN are all disconnected, in operation 601, if a connect event is generated in operation 602, the virtual miniport driver 410 reports a connection state to the protocol driver 310 in an upper layer, in operation 603. The upper layer protocol driver 310 determines whether a connected adapter is an 802.3 adapter, in operation 604, and if the connected adapter is the 802.3 adapter, the upper layer protocol driver 310 communicates with the 802.3 wired LAN, in operation 607. While communicating with the 802.3 wired LAN, if an 802.11 connect event is generated, in operation 605, 802.11 connection state information is updated in operation 606.

If the connected adapter is an 802.11 adapter not an 802.3 adapter, in operation 604, 802.11 adapter information is mapped to a virtual adapter in operation 608. The upper layer protocol driver 310 communicates with the 802.11 wireless LAN, in operation 609.

While communicating with the 802.11 adapter, if an 802.3 connect event is generated in operation 610, 802.3 adapter information is mapped to the virtual adapter in operation 611. The upper layer protocol driver 310 communicates with the 802.3 wired LAN, in operation 612.

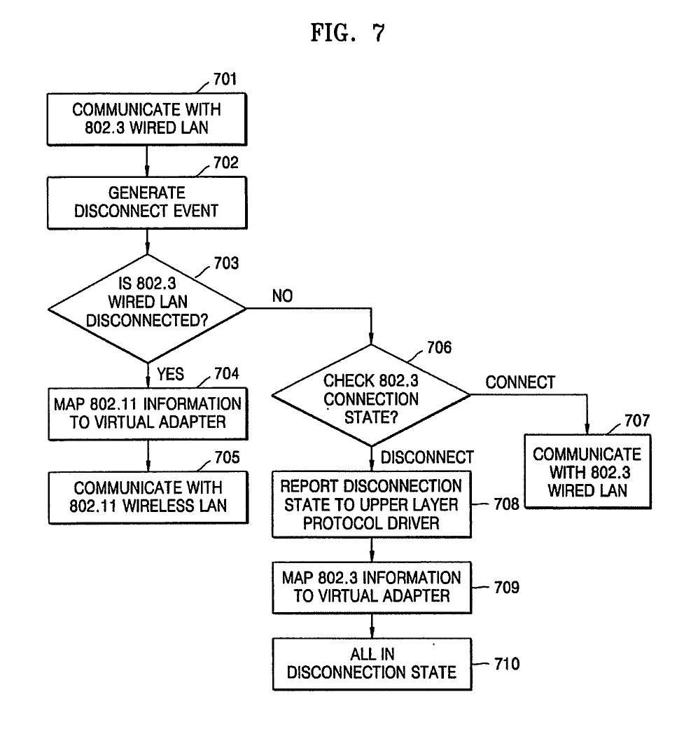

FIG. 7 is a flowchart illustrating a disconnecting operation according to an embodiment of the present invention.

Referring to FIG. 7, when the upper layer protocol driver 310 communicates with an 802.3 wired LAN in operation 701, if a disconnect event is generated in operation 702, the virtual adapter controller 411 determines whether the disconnected adapter is an 802.3 adapter, in operation 703, and if the disconnected adapter is an 802.3 adapter, 802.11 adapter information is re-mapped to a virtual adapter in operation 704. Then, the upper layer protocol driver 310 communicates with an 802.11 wireless LAN in operation 705.

If the disconnected adapter is not an 802.3 adapter, the connection state of the 802.3 wired LAN is checked in operation 706.

If the 802.3 wired LAN is found to be connected, the upper layer protocol driver 310 communicates with the 802.3 wired LAN in operation 707.

If the 802.3 wired LAN is found to be disconnected, the virtual miniport driver 410 reports the disconnection state to the upper layer protocol driver 310 in operation 708, and 802.3 adapter information is re-mapped to the virtual adapter in operation 709. Then, the 802.3 wired LAN and the 802.11 wireless LAN are all in a disconnected state.

As described above, according to embodiments of the present invention, a unique virtual adapter for heterogeneous communication media is generated, and one IP address is assigned to the generated virtual adapter. A high speed wired LAN is used when both a wired LAN and a wireless LAN are connected, and if the wired LAN is disconnected, the disconnection is automatically detected, and packets are rerouted to the wireless LAN. Accordingly, protocol drivers, such as TCP/IP, recognize only the virtual adapter. Therefore, since the IP address does not change even if a port address changes, a continuous session can be maintained.

That is, seamless handoff from the wired LAN to the wireless LAN is possible, since the TCP/IP session is maintained with the same IP address. Also, since the same MAC address is used, communication continuity is guaranteed with the IP address assigned by DHCP. Also, seamless communication is possible in a stateless auto-configuration environment where an IPv6 address is generated according to MAC addresses, in a next generation internet IPv6.

The present invention may be embodied in a general-purpose computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present invention may be embodied as a computer-readable medium having a computer-readable program code unit embodied therein for causing a number of computer systems connected via a network to effect distributed processing. The functional programs, code and code segments for embodying the present invention may be easily deducted by programmers in the art to which the present invention belongs.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A communication adapter switching method in a system having a plurality of communication adapters, the method comprising:
setting addresses of the plurality of communication adapters a same address of a first of the plurality of communication adapters;
setting a packet filtering mode of all the communication adapters other than the first communication adapter to a mode in which all packets are accepted; and
switching from one of the plurality of communication adapters to another when the one communication adapter is disconnected during communication.

2. A communication adapter switching method in a system having a plurality of communication adapters, the method comprising:
setting a media access control (MAC) address of a wired LAN communication adapter a same MAC address of a wireless LAN communication adapter;
setting a packet filtering mode of the wired LAN communication adapter to a promiscuous mode in which all packets are accepted; and
switching from the wired LAN communication adapter to the wireless LAN communication adapter using wireless LAN information, when the wired LAN is disconnected during communication using the wired LAN communication adapter.

3. The method of claim 2, further comprising:
switching from the wireless LAN communication adapter to the wired LAN communication adapter using wired LAN information, when an event is generated indicating that the wired LAN is connected during communication using the wireless LAN communication adapter.

4. The method of claim 2, further comprising:
setting a packet filtering mode of the wired LAN communication adapter to a direct, multicast, or broadcast mode.

5. The method of claim 2, further comprising:
mapping the wireless LAN information to a virtual adapter if the wired LAN communication adapter is disconnected.

6. A communication adapter switching apparatus in a system having a plurality of communication adapters, the apparatus comprising:
a virtual adapter which sets the addresses of the plurality of communication adapters equal to an address of a first of the plurality of communication adapters, and setting a packet filtering mode of all the communication adapters other than the first communication adapter to a mode in which all packets can be accepted; and
a virtual protocol driver which switches from one of the plurality of communication adapters to another when the one communication adapter is disconnected during communication.

7. A communication adapter switching apparatus in a system having a plurality of communication adapters, the apparatus comprising:
a virtual adapter which sets a MAC address of a wired LAN communication adapter equal to the MAC address of a wireless LAN communication adapter, and sets a packet filtering mode of the wired LAN communication adapter to a promiscuous mode in which all packets are accepted; and
a virtual protocol driver which switches from the wired LAN communication adapter to the wireless LAN communication adapter using wireless LAN information, when the wired LAN is disconnected during communication using the wired LAN communication adapter.

8. The apparatus of claim 7, wherein the virtual protocol driver comprises a link state detector which provides a connection or disconnection state every time a connection or disconnection event is generated.

9. The apparatus of claim 8, wherein the virtual protocol driver further comprises an optimal adapter selector which determines an optimal adapter for communication based on information provided by the link state detector.

10. The apparatus of claim 9, wherein packets received from a physical adapter are unconditionally transmitted to the virtual adapter, and packets to be transmitted to the physical adapter are transmitted to the determined optimal adapter.

11. A communication adapter switching method in a system having a plurality of communication adapters, the method comprising:
checking whether a wired LAN (Local Area Network) is connected;
generating a wireless LAN connect event if the wired LAN is connected;
updating the wireless LAN connect information; and
communicating with the wired LAN.

12. The method of claim 11, further comprising:
mapping the wireless LAN information to a virtual adapter if the wired LAN is not connected;
communicating with the wireless LAN;
generating a connect event of wired LAN;
mapping information to the virtual adapter; and
communicating with the wired LAN.

13. The method of claim 11, wherein the wired LAN is an 802.3 wired LAN.

14. The method of claim 11, wherein the wireless LAN is an 802.11 wireless LAN.

15. A method of selecting an optimal adapter, the method comprising:
querying the connection state;
detecting connection state information;
selecting an optimal adapter based on the connection state information; and
mapping information of selected optimal adapter.

16. The method of claim 15, wherein the optimal adapter is the wired LAN if both an wired LAN and an wireless LAN are connected, or the one which is connected to.

17. The method of claim 16, wherein the wired LAN is an 802.3 wired LAN.

18. The method of claim 16, wherein the wireless LAN is an 802.11 wireless LAN.
